(19) United States
(12) Patent Application Publication
(10) Pub. No.: US 2024/0316852 A1
(43) Pub. Date: Sep. 26, 2024

(54) Mold Assembly for PVA Plastic Material and Shunt Cone of the Same

(71) Applicants: FT INTERNATIONAL CO., LTD., Taichung City (TW); JYUN HE TECHNOLOGY COMPANY LIMITED, Zhunan Township (TW)

(72) Inventors: Min Hung Chen, Taichung City (TW); Fang-Yun Lin, Zhunan Township (TW); You-Hung Lu, Zhunan Township (TW)

(21) Appl. No.: 18/332,862

(22) Filed: Jun. 12, 2023

(30) Foreign Application Priority Data
Mar. 21, 2023 (TW) 112202525

(51) Int. Cl. B29C 48/27; B29C 48/00; B29C 48/32; B29C 55/28

(52) U.S. Cl. CPC B29C 48/272; B29C 48/0018; B29C 48/32; B29C 55/28; B29K 2031/04

(57) ABSTRACT

A mold assembly has a pressing mold, a shunt cone, and a mold cap. The shunt cone is disposed in the pressing mold to define a conical pressing channel. The shunt cone has a body, an inlet channel, and an outlet channel. The body has a conical cone portion. The inlet channel has an extension height from a top of shunt cone being higher than an extension height of the inlet channel from the top of the shunt cone. The mold cap is attached to a bottom of the pressing mold and has a lower mold cavity to allow the cone portion to extend into the lower mold cavity and to define a conical shaped connection channel. The connection channel communicates with the pressing channel, and a material input channel is defined in the mold cap and communicating with the connection channel.

### FIELD OF INVENTION

The present invention relates to a mold assembly, particularly to a blow mold assembly for PVA plastic material.

### BACKGROUND OF THE INVENTION

To form plastic bags, with reference to FIG. 7, melt plastic material is provided by a material source and is pressed into a blow mold 52. The melt plastic material is shunted in the blow mold 52 to form a tubular film. An inlet channel is defined in the blow mold 52 to allow air to flow into the tubular plastic film to keep the film to expand to a tubular shape. After cooling, shaping, rolling, and cutting processes, plastic bags are formed

However, moisture exists during the forming process of the tubular plastic film. If the moisture cannot be effectively exhausted, the tubular plastic film may be broken and the quality and yield of forming the plastic bags will be reduced.

### SUMMARY OF THE INVENTION

The objective of the present invention is to provide a mold assembly that can effectively exhaust moisture during the forming processes of plastic bags to increase the quality and yield for forming plastic bags.

To achieve the objective, the present invention provides a mold assembly has a pressing mold, a shunt cone, and a mold cap. The pressing mold has a mold cavity defined in the pressing mold. The shunt cone is disposed in the mold cavity of the pressing mold to define a pressing channel between the shunt cone and the pressing mold. The pressing channel has a conical shape having a diameter gradually decreasing from a bottom of the mold cavity to a top of the mold cavity. The shunt cone has a body, an inlet channel, and an outlet channel. The body has a conical cone portion formed on an end of the body. The inlet channel is defined in the body of the shunt cone. The outlet channel is defined in the body of the shunt cone, wherein the inlet channel has an extension height from a top of shunt cone being higher than an extension height of the inlet channel from the top of the shunt cone. The mold cap is attached to a bottom of the pressing mold and has a lower mold cavity defined in a top of the mold cap and having a shape corresponding to a shape of the cone portion of the shunt cone to allow the cone portion of the shunt cone to extend into the lower mold cavity and to define a conical shaped connection channel between the cone portion of the shunt cone and the mold cap. The connection channel communicates with the pressing channel, and a material input channel is defined in the mold cap and communicating with the connection channel.

Wherein, the inlet channel is L-shaped to define a lateral channel and a longitudinal channel, the outlet channel is L-shaped to define a lateral channel and a longitudinal channel, the cone portion of the shunt cone has an inlet rib and an outlet rib diametrically protruding from the cone portion, and the inlet rib and the outlet rib are hollow to respectively define the lateral channel of the inlet channel and the lateral channel of the outlet channel, and the longitudinal channels of the inlet channel and the outer channel extend through the top of the shunt cone, and the pressing mold further comprises an inlet hole communicating with the lateral channel of the inlet channel and an outlet hole communicating with the lateral channel of the outlet channel.

Wherein, the body of the shunt cone is composed of three components and comprises a fixing blot extends through the three components to form the body of the shunt cone.

Wherein, the inlet channel and the outlet channel are longitudinally formed through the body of the shunt cone, such that the inlet channel and the outlet channel are substantially I-shaped, and the mold cap further comprises an inlet hole communicating with a bottom of the inlet channel and an outlet hole communicating with a bottom of the outlet channel.

The present invention also provides a shunt cone for a mold assembly for PVA plastic material having a body, an inlet channel, and an outlet channel. The body has a conical cone portion formed on an end of the body. The inlet channel is defined in the body of the shunt cone. The outlet channel is defined in the body of the shunt cone, wherein the inlet channel has an extension height from a top of shunt cone being higher than an extension height of the inlet channel from the top of the shunt cone.

With the aforementioned features, because the extension height of the outlet channel is higher than the extension height of the inlet channel, the moisture existing in tubular plastic film can be effectively exhausted from the outlet channel. Accordingly, the annular plastic film can be kept from being broken, and the quality and yield of forming plastic bags can be improved.

### BRIEF DESCRIPTION OF THE DRAWINGS

FIG. 1 is a front view of a first embodiment of a mold assembly in accordance with the present invention;

FIG. 2 is a cross sectional side view of the mold assembly in FIG. 1;

FIG. 3 is a bottom view of the pressing mold and the shunt cone of the mold assembly in FIG. 1;

FIG. 4 is an enlarged cross sectional side view of a first embodiment of a shunt cone in accordance with the present invention;

FIG. 5 is a cross sectional side view of a second embodiment of a mold assembly in accordance with the present invention;

FIG. 5A is an enlarged cross sectional side view of a connection between an inlet channel and an inlet hole in a mold cap of the mold assembly in FIG. 5;

FIG. 6 is an enlarged cross sectional side view of a second embodiment of a shunt cone in accordance with the present invention; and

FIG. 7 is a schematic diagram for a conventional process for forming plastic bags.

### DETAILED DESCRIPTION OF THE PREFERRED EMBODIMENTS

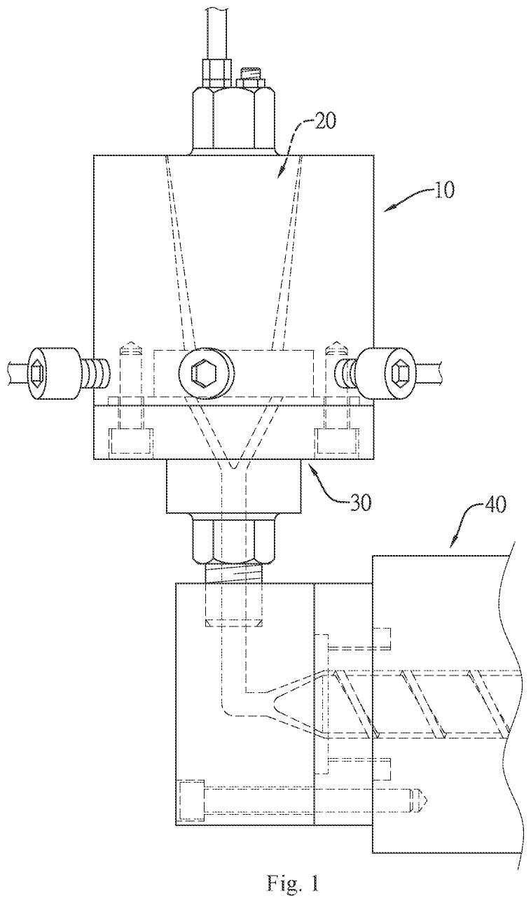

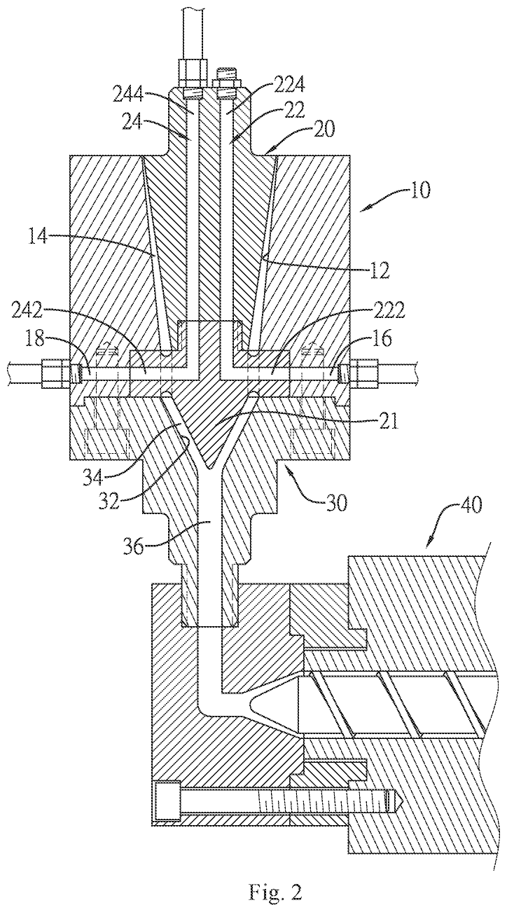

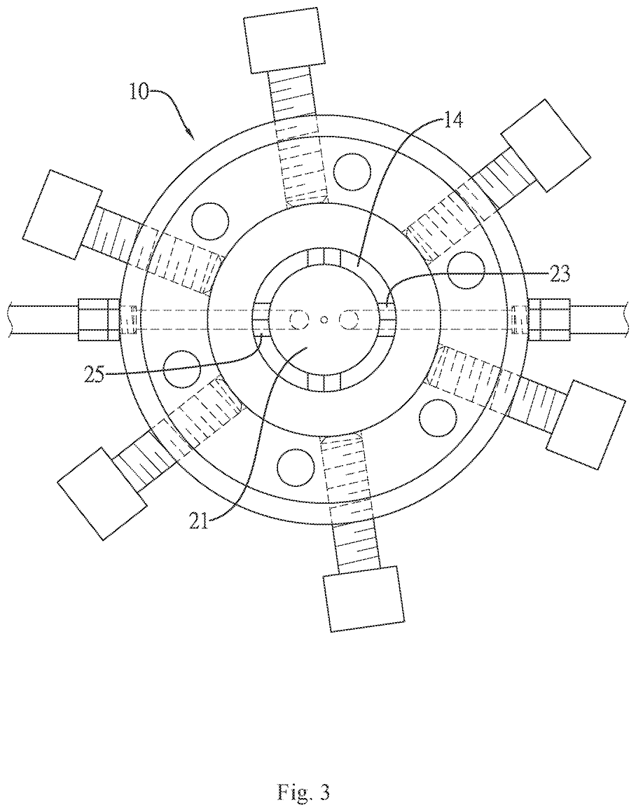

The present invention is related to a mold assembly for PVA plastic material, and the mold assembly is applied to form Polyvinyl Alcohol (PVA) plastic material. With reference to FIG. 1 to FIG. 3, the mold assembly in accordance with the present invention comprises a pressing mold 10, a shunt cone 20, and a mold cap 30. The pressing mold 10 has a mold cavity 12 defined in the pressing mold 10. The shunt cone 20 is disposed in the mold cavity 12 of the pressing mold 10 to defined a pressing channel 14 between the shunt cone 20 and the pressing mold 10. The pressing channel 14 has a conical shape having a diameter gradually decreasing from a bottom of the mold cavity 12 to a top of the mold cavity 12. The shunt cone 20 comprises a body. The body has a conical cone portion 21 formed on an end of the body and extending out of the bottom of the mold cavity 12. The mold cap 30 is attached to a bottom of the pressing mold 10 and has a lower mold cavity 32 defined in a top of the mold cap 30. The lower mold cavity 32 has a shape corresponding to a shape of the cone portion 21 of the shunt cone 20 to allow the cone portion 21 of the shunt cone 20 to extend into the lower mold cavity 32 and to define a conical shaped connection channel 34 between the cone portion 21 of the shunt cone 20 and the mold cap 30. The connection channel 34 communicates with the pressing channel 14, and a material input channel 36 is defined in the mold cap 30, communicates with the connection channel 34, and is connected to a material source 40.

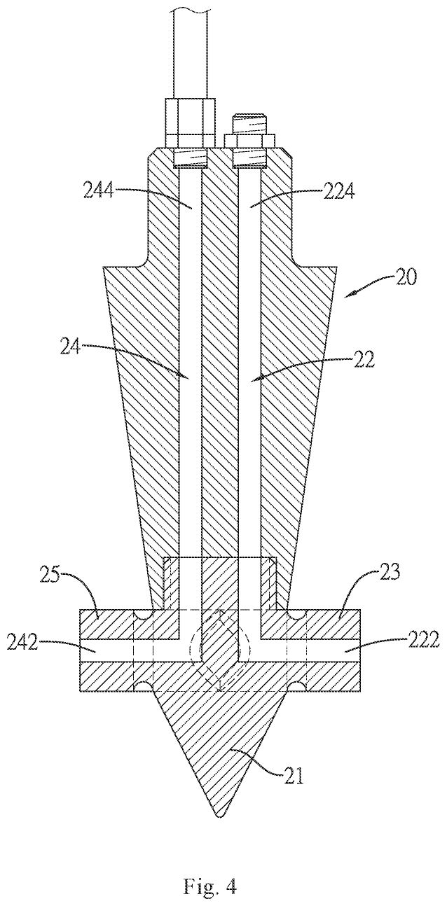

With further reference to FIG. 4. the shunt cone 20 further comprises an inlet channel 22 and an outlet channel 24. In the first embodiment, the inlet channel 22 and the outlet channel 24 are L-shaped to respectively define a lateral channel 222, 242 and a longitudinal channel 224,244. The cone portion 21 of the shunt cone 20 has an inlet rib 23 and an outlet rib 25 diametrically protruding from the cone portion 21. The inlet rib 23 and the outlet rib 25 are hollow to respectively define the lateral channel 222 of the inlet channel 22 and the lateral channel 242 of the outlet channel 24. The longitudinal channels 224, 244 of the inlet channel 22 and the outer channel 24 extend through the top of the shunt cone 20, and the inlet channel 22 has an extension height from a top of shunt cone 20 being higher than an extension height of the inlet channel 24 from the top of the shunt cone 20. In addition, the pressing mold 10 further comprises an inlet hole 16 communicating with the lateral channel 224 of the inlet channel 22 and an outlet hole 18 communicating with the lateral channel 242 of the outlet channel 24.

With such an arrangement, when melt plastic material flows from the material source 40 and into the material input channel 36, the melt plastic material will pass through the conical connection channel 34 and into the pressing channel between the pressing mold 10 and the shunt cone 20. After the melt plastic material is pressed out of the pressing channel 14, a tubular plastic film is formed due to the shape of the conical pressing channel 14. At this time, air is inputted from the input hole 16 in the pressing mold 10, passes through the inlet channel 22 in the shunt cone 20 and is exhausted from the inlet channel 22. The plastic film can be kept at a tubular shape due to the pressure of the air, and the plastic film can be cooled down and shaped. After rolling and cutting processes, plastic bags are formed.

At this time, air in the tubular film can be discharged via the outlet channel 24, so air and moisture in the tubular plastic film can be discharged from the outlet channel 24 and out of the outlet hole 18 in the pressing mold 10 at the same time. Because the extension height of the outlet channel 24 is higher than that of the inlet channel 22, the moisture at a lighter weight in the tubular plastic film can be effectively exhausted out from the outlet channel 24. Accordingly, the tubular plastic film can be kept from being broken to improve the quality and yield of forming the plastic bags.

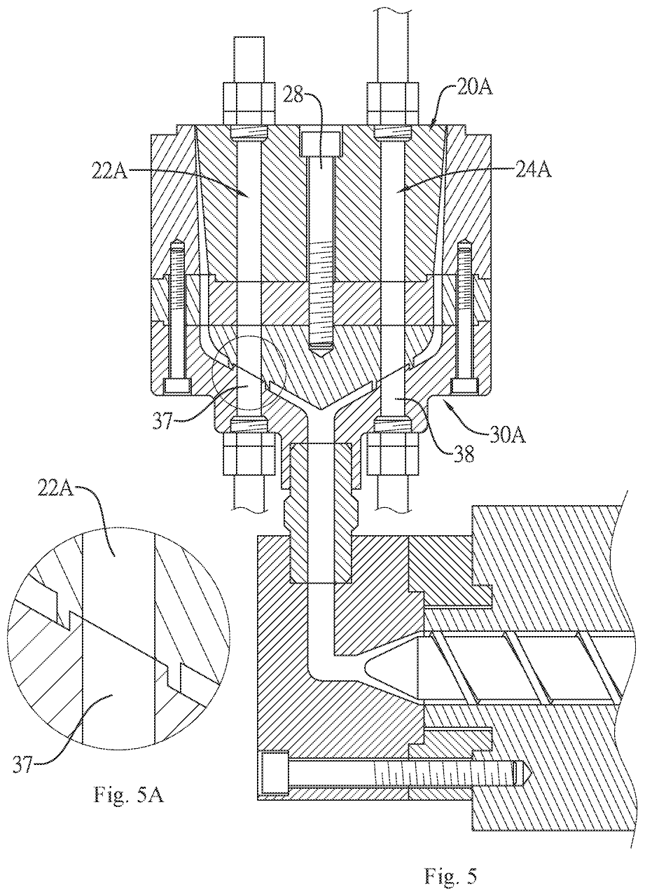

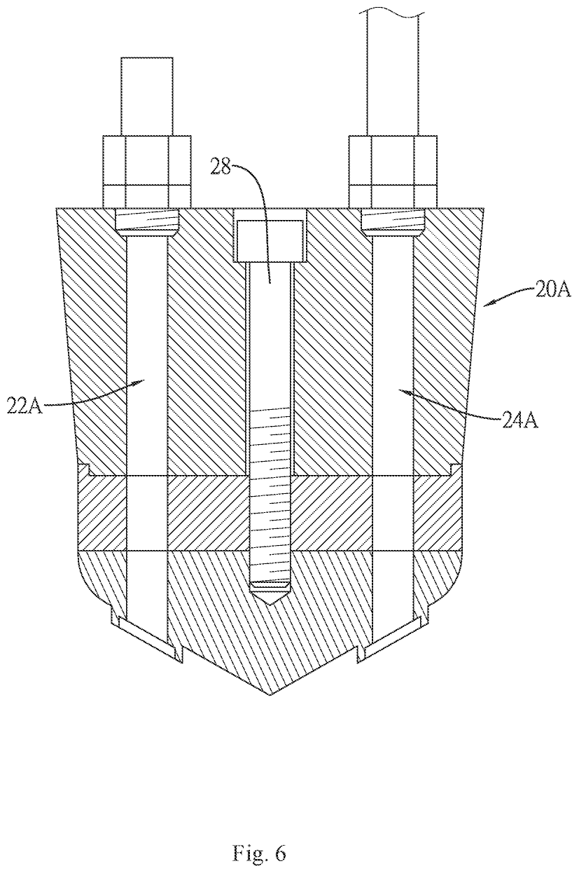

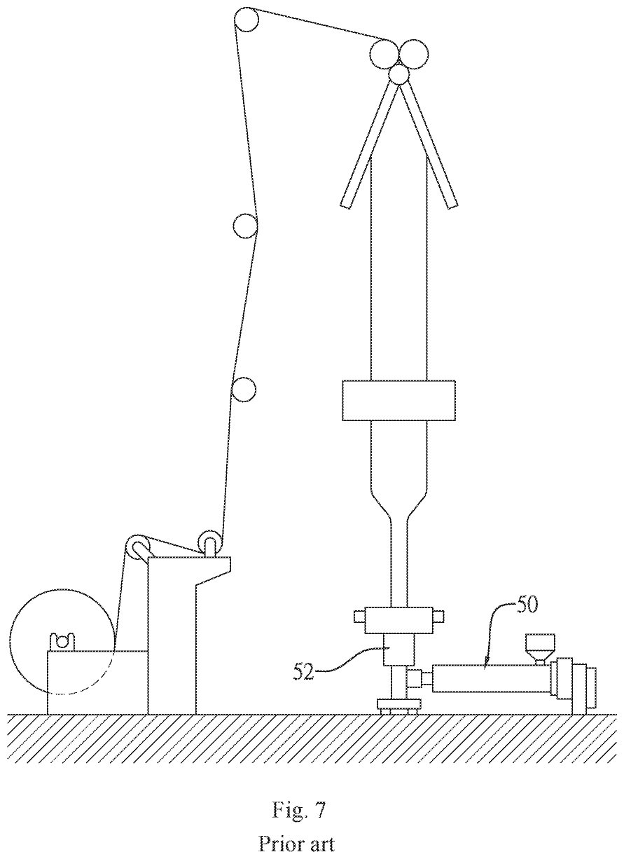

With reference to FIGS. 5 and 6, in a second embodiment, the body of the shunt cone 20A is composed of three components and comprises a fixing blot 28 extends through the three components to form the body of the shunt cone 20A. The inlet channel 22A and the outlet channel 24A are longitudinally formed through the body of the shunt cone 20A, such that the inlet channel 22A and the outlet channel 24A are substantially I-shaped. The mold cap 30A further comprises an inlet hole 37 communicating with a bottom of the inlet channel 22A and an outlet hole 38 communicating with a bottom of the outlet channel 24A. Although the shapes of the inlet channel 22A and the outlet channel 24A in the second embodiment are different from those of the inlet channel 22 and the outlet channel 24 in the first embodiment, they can achieve the same functions. Therefore, the shape of inlet channel 22 and the outlet channel 24 in the present invention is not limited.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mold assembly for PVA plastic material comprising:
a pressing mold having a mold cavity defined in the pressing mold;
a shunt cone disposed in the mold cavity of the pressing mold to define a pressing channel between the shunt cone and the pressing mold, the pressing channel having a conical shape having a diameter gradually decreasing from a bottom of the mold cavity to a top of the mold cavity, and the shunt cone comprising
a body having a conical cone portion formed on an end of the body;
an inlet channel defined in the body of the shunt cone; and
an outlet channel defined in the body of the shunt cone, wherein the inlet channel has an extension height from a top of shunt cone being higher than an extension height of the inlet channel from the top of the shunt cone; and
a mold cap attached to a bottom of the pressing mold and having a lower mold cavity defined in a top of the mold cap and having a shape corresponding to a shape of the cone portion of the shunt cone to allow the cone portion of the shunt cone to extend into the lower mold cavity and to define a conical shaped connection channel between the cone portion of the shunt cone and the mold cap, the connection channel communicating with the pressing channel, and a material input channel defined in the mold cap and communicating with the connection channel.

2. The mold assembly as claimed in claim 1, wherein the inlet channel is L-shaped to define a lateral channel and a longitudinal channel;
the outlet channel is L-shaped to define a lateral channel and a longitudinal channel;
the cone portion of the shunt cone has an inlet rib and an outlet rib diametrically protruding from the cone portion, and the inlet rib and the outlet rib are hollow to respectively define the lateral channel of the inlet channel and the lateral channel of the outlet channel, and the longitudinal channels of the inlet channel and the outer channel extend through the top of the shunt cone; and
the pressing mold further comprises an inlet hole communicating with the lateral channel of the inlet channel and an outlet hole communicating with the lateral channel of the outlet channel.

3. The mold assembly as claimed in claim 1, wherein the body of the shunt cone is composed of three components and comprises a fixing blot extends through the three components to form the body of the shunt cone.

4. The mold assembly as claimed in claim 3, wherein the inlet channel and the outlet channel are longitudinally formed through the body of the shunt cone, such that the inlet channel and the outlet channel are substantially I-shaped; and
the mold cap further comprises an inlet hole communicating with a bottom of the inlet channel and an outlet hole communicating with a bottom of the outlet channel.

5. A shunt cone for a mold assembly for PVA plastic material comprising
a body having a conical cone portion formed on an end of the body;
an inlet channel defined in the body of the shunt cone; and
an outlet channel defined in the body of the shunt cone, wherein the inlet channel has an extension height from a top of shunt cone being higher than an extension height of the inlet channel from the top of the shunt cone.

6. The shunt cone as claimed in claim 5, wherein the inlet channel is L-shaped to define a lateral channel and a longitudinal channel;
the outlet channel is L-shaped to define a lateral channel and a longitudinal channel;
the cone portion of the body has an inlet rib and an outlet rib diametrically protruding from the cone portion, and the inlet rib and the outlet rib are hollow to respectively define the lateral channel of the inlet channel and the lateral channel of the outlet channel, and the longitudinal channels of the inlet channel and the outer channel extend through the top of the shunt cone.

7. The shunt cone as claimed in claim 5, wherein the body of the shunt cone is composed of three components and comprises a fixing blot extends through the three components to form the body of the shunt cone.

8. The shunt cone as claimed in claim 7, wherein the inlet channel and the outlet channel are longitudinally formed through the body of the shunt cone, such that the inlet channel and the outlet channel are substantially I-shaped.
